(19) United States
(12) Patent Application Publication
(10) Pub. No.: US 2022/0398591 A1
(43) Pub. Date: Dec. 15, 2022

(54) SYSTEMS AND METHODS FOR BIOMETRIC TRANSACTION MANAGEMENT

(71) Applicant: Selfiecoin, Inc., Brooklyn, NY (US)

(72) Inventor: Sharron Battle, Las Vegas, NV (US)

(21) Appl. No.: 17/583,888

(22) Filed: Jan. 25, 2022

Related U.S. Application Data
(63) Continuation of application No. 15/881,511, filed on Jan. 26, 2018, now abandoned.
(60) Provisional application No. 62/457,486, filed on Feb. 10, 2017.

(51) Int. Cl. G06Q 20/40; G06Q 20/10; G06Q 20/06

(52) U.S. Cl. CPC G06Q 20/40145; G06Q 20/1085; G06Q 20/0655; G06Q 2220/00

(57) ABSTRACT

Sensor data may be captured by at least one sensor in communication with at least one processor. The at least one processor may extract biometric data from the sensor data and compare the biometric data with stored biometric data for a first user stored in a memory in communication with the at least one processor. The at least one processor may determine that the biometric data matches the stored biometric data based on the comparing. The at least one processor may execute a transaction between the first user and a second user, the transaction comprising an exchange of digital currency between the users. The at least one processor may create a block in a distributed blockchain, the block comprising data memorializing the at least one transaction including information describing the exchange of the digital currency and at least one of the biometric data and the stored biometric data.

### CROSS-REFERENCE TO RELATED APPLICATION

This application claims priority from U.S. Provisional Application No. 62/457,486, entitled “METHOD FOR CONDUCTING A BIOMETRIC TRANSACTION USING A READER,” filed Feb. 10, 2017, the entirety of which is incorporated by reference herein.

### BRIEF DESCRIPTIONS OF THE DRAWINGS

FIG. 1 shows a cryptocurrency network according to an embodiment of the present disclosure.

FIG. 2 shows a computing device according to an embodiment of the present disclosure.

FIG. 3A shows a server device according to an embodiment of the present disclosure.

FIG. 3B shows a cryptocurrency service according to an embodiment of the present disclosure.

FIG. 4 shows a template creation process according to an embodiment of the present disclosure.

FIG. 5 shows a template improvement process according to an embodiment of the present disclosure.

FIG. 6 shows a transaction process according to an embodiment of the present disclosure.

FIGS. 7A-7C show a standalone selfie reader according to an embodiment of the present disclosure.

FIG. 8 shows an ATM according to an embodiment of the present disclosure.

FIG. 9 shows a verification interface according to an embodiment of the present disclosure.

### DETAILED DESCRIPTION OF SEVERAL EMBODIMENTS

Systems and methods described herein may provide digital assets such as cryptocurrencies that may be secured with biometric information. For example, a cryptocurrency may be generated and maintained by a decentralized network of peer computers creating assets or “coins” and creating an immutable, agreed-upon record of transactions involving the coins. Coins may be owned and exchanged by users. In order to exchange coins, users may access personal accounts. Given the valuable nature of the coins and transactions, advanced authentication systems and methods may improve the security of the accounts and trustworthiness of the transactions. For example, because the transaction record is irreversible and universally established, fraud prevention may be difficult to undo, incentivizing improved account access security. Furthermore, authentication systems and methods that do not require arbitrary passwords or other codes may prevent the loss of coin value to an overall marketplace when a user forgets a password, for example.

### System Architecture

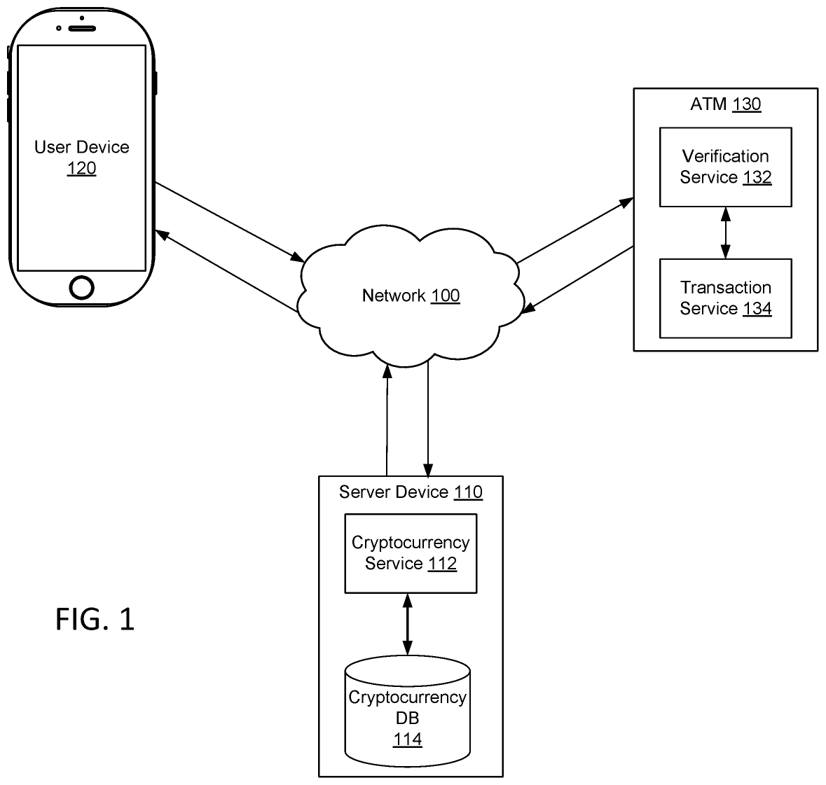

FIG. 1 shows a cryptocurrency network 100 according to an embodiment of the present disclosure. Network 100 may include the Internet, one or more local or enterprise networks, other networks, and/or a combination thereof.

One or more user devices 120 may be connected to network 100. User devices 120 may include devices such as smartphones, laptops, desktops, workstations, tablets, and/or other computing devices. While one user device 120 is shown in FIG. 1 for ease of illustration, any number of user devices 120 may connect to network 100. User devices 120 may include hardware, software, and/or firmware configured to capture user biometric data and/or communicate with other computing devices to effect transactions as described herein. For example, user device 120 may include an app, web browser, or other hardware, software, and/or firmware configured to receive user biometric information and/or user-entered information and communicate with server device 110, as described in greater detail below.

One or more server devices 110 may be connected to network 100. Server device 110 may be a computing device, such as a server or other computer. Server device 110 may include cryptocurrency service 112 configured to receive biometric data and/or other information from user devices 120, verify user identities, perform transactions, and/or record the transactions. Server device 110 may include cryptocurrency database 114. Cryptocurrency database 114 may include at least a subset of data used to verify user identities in some embodiments and/or may store transaction records, for example, as described in greater detail below.

Server device 110 is depicted as a single server including a single cryptocurrency service 112 and cryptocurrency database 114 in FIG. 1 for ease of illustration, but those of ordinary skill in the art will appreciate that server device 110 may be embodied in different forms for different implementations. For example, server device 110 may include a plurality of servers. Cryptocurrency service 112 may comprise a variety of services such as an application programming interface (API) configured for handling inbound requests for validation and/or transactions and/or a database service configured to store, search, and retrieve data from cryptocurrency database 114, for example.

One or more cryptocurrency automatic teller machines (ATMs) 130 may be connected to network 100. ATM 130 may include verification service 132, which may be configured to verify user identities using biometric information as described in greater detail below, and transaction service 134, which may be configured to perform cryptocurrency transactions as described in greater detail below, including communicating with server device 110 in some embodiments. ATM 130 may be configured to dispense cash as a result of a cryptocurrency transaction, for example by a user converting cryptocurrency to cash currency.

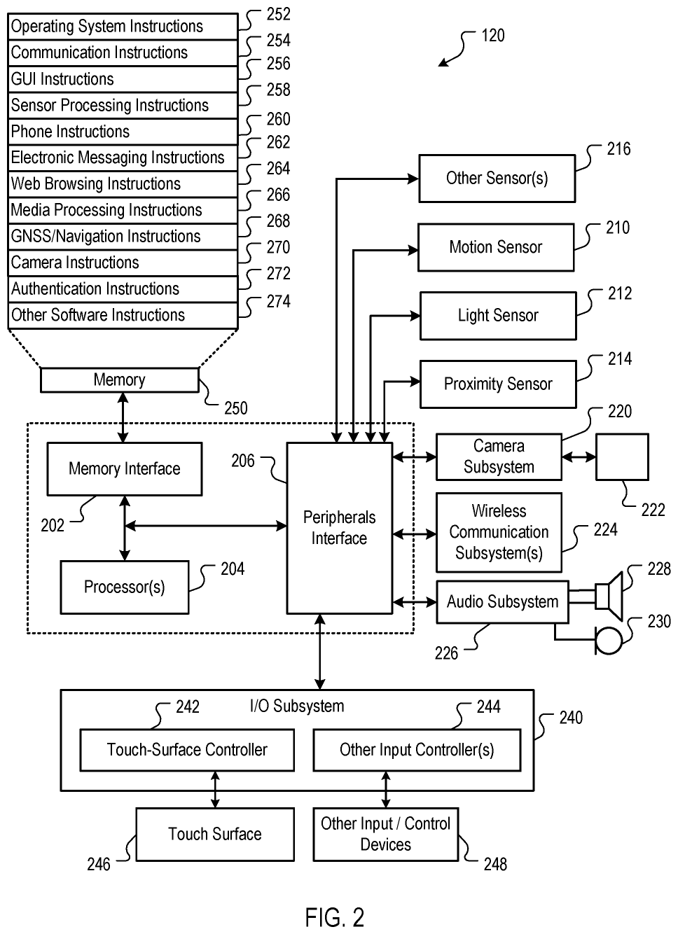

FIG. 2 is a block diagram of an example user device 120, for example a computing device configured to function as a user device 120 as described herein. The user device 120 may include a memory interface 202, one or more data processors, image processors, and/or central processing units 204, and a peripherals interface 206. The memory interface 202, the one or more processors 204, and/or the peripherals interface 206 may be separate components or may be integrated in one or more integrated circuits. The various components in the user device 120 may be coupled by one or more communication buses or signal lines.

Sensors, devices, and subsystems may be coupled to the peripherals interface 206 to facilitate multiple functionalities. For example, a motion sensor 210, a light sensor 212, and a proximity sensor 214 may be coupled to the peripherals interface 206 to facilitate orientation, lighting, and proximity functions. Other sensors 216 may also be connected to the peripherals interface 206, such as a global navigation satellite system (GNSS) (e.g., GPS receiver), a temperature sensor, a biometric sensor, magnetometer, or other sensing device, to facilitate related functionalities.

A camera subsystem 220 and an optical sensor 222, e.g., a charged coupled device (CCD) or a complementary metal-oxide semiconductor (CMOS) optical sensor, may be utilized to facilitate camera functions, such as recording photographs and video clips. The camera subsystem 220 and the optical sensor 222 may be used to collect images of a user to be used during authentication of a user, e.g., by performing facial recognition analysis.

Communication functions may be facilitated through one or more wired and/or wireless communication subsystems 224, which can include radio frequency receivers and transmitters and/or optical (e.g., infrared) receivers and transmitters. For example, the BTLE and/or WiFi communications described above may be handled by wireless communication subsystems 224. The specific design and implementation of the communication subsystems 224 may depend on the communication network(s) over which the user device 120 is intended to operate. For example, the user device 120 may include communication subsystems 224 designed to operate over a GSM network, a GPRS network, an EDGE network, a WiFi or WiMax network, and a Bluetooth™ network. For example, the wireless communication subsystems 224 may include hosting protocols such that the user device 120 can be configured as a base station for other wireless devices and/or to provide a WiFi service.

An audio subsystem 226 may be coupled to a speaker 228 and a microphone 530 to facilitate voice-enabled functions, such as speaker recognition, voice replication, digital recording, and telephony functions. The audio subsystem 226 may be configured to facilitate processing voice commands, voice printing, and voice authentication, for example.

The I/O subsystem 240 may include a touch-surface controller 242 and/or other input controller(s) 244. The touch-surface controller 242 may be coupled to a touch surface 246. The touch surface 246 and touch-surface controller 242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 246.

The other input controller(s) 244 may be coupled to other input/control devices 248, such as one or more buttons, rocker switches, thumb-wheel, infrared port, USB port, and/or a pointer device such as a stylus. The one or more buttons (not shown) may include an up/down button for volume control of the speaker 228 and/or the microphone 230.

In some implementations, a pressing of the button for a first duration may disengage a lock of the touch surface 246; and a pressing of the button for a second duration that is longer than the first duration may turn power to the user device 120 on or off. Pressing the button for a third duration may activate a voice control, or voice command, module that enables the user to speak commands into the microphone 230 to cause the device to execute the spoken command. The user may customize a functionality of one or more of the buttons. The touch surface 246 can, for example, also be used to implement virtual or soft buttons and/or a keyboard.

In some implementations, the user device 120 may present recorded audio and/or video files, such as MP3, AAC, and MPEG files. In some implementations, the user device 120 may include the functionality of an MP3 player, such as an iPod™. The user device 120 may, therefore, include a 36-pin connector and/or 8-pin connector that is compatible with the iPod. Other input/output and control devices may also be used.

The memory interface 202 may be coupled to memory 250. The memory 250 may include high-speed random access memory and/or non-volatile memory, such as one or more magnetic disk storage devices, one or more optical storage devices, and/or flash memory (e.g., NAND, NOR). The memory 250 may store an operating system 252, such as Darwin, RTXC, LINUX, UNIX, OS X, WINDOWS, or an embedded operating system such as VxWorks.

The operating system 252 may include instructions for handling basic system services and for performing hardware dependent tasks. In some implementations, the operating system 252 may be a kernel (e.g., UNIX kernel). In some implementations, the operating system 252 may include instructions for performing voice authentication.

The memory 250 may also store communication instructions 254 to facilitate communicating with one or more additional devices, one or more computers and/or one or more servers. The memory 250 may include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GNSS/Navigation instructions 268 to facilitate GNSS and navigation-related processes and instructions; and/or camera instructions 270 to facilitate camera-related processes and functions.

The memory 250 may store authentication instructions 272 to facilitate authentication functions for interacting with other computers in the network to perform cryptocurrency-based transactions, as described herein.

The memory 250 may also store other software instructions 274, such as web video instructions to facilitate web video-related processes and functions; and/or web shopping instructions to facilitate web shopping-related processes and functions. In some implementations, the media processing instructions 266 may be divided into audio processing instructions and video processing instructions to facilitate audio processing-related processes and functions and video processing-related processes and functions, respectively.

Each of the above identified instructions and applications may correspond to a set of instructions for performing one or more functions described herein. These instructions need not be implemented as separate software programs, procedures, or modules. The memory 250 may include additional instructions or fewer instructions. Furthermore, various functions of the user device 120 may be implemented in hardware and/or in software, including in one or more signal processing and/or application specific integrated circuits.

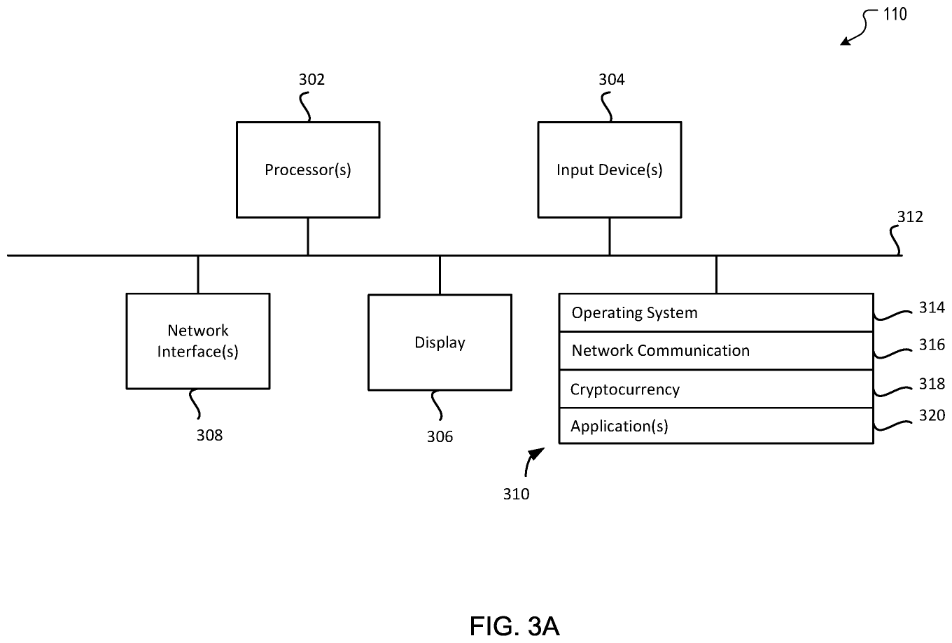

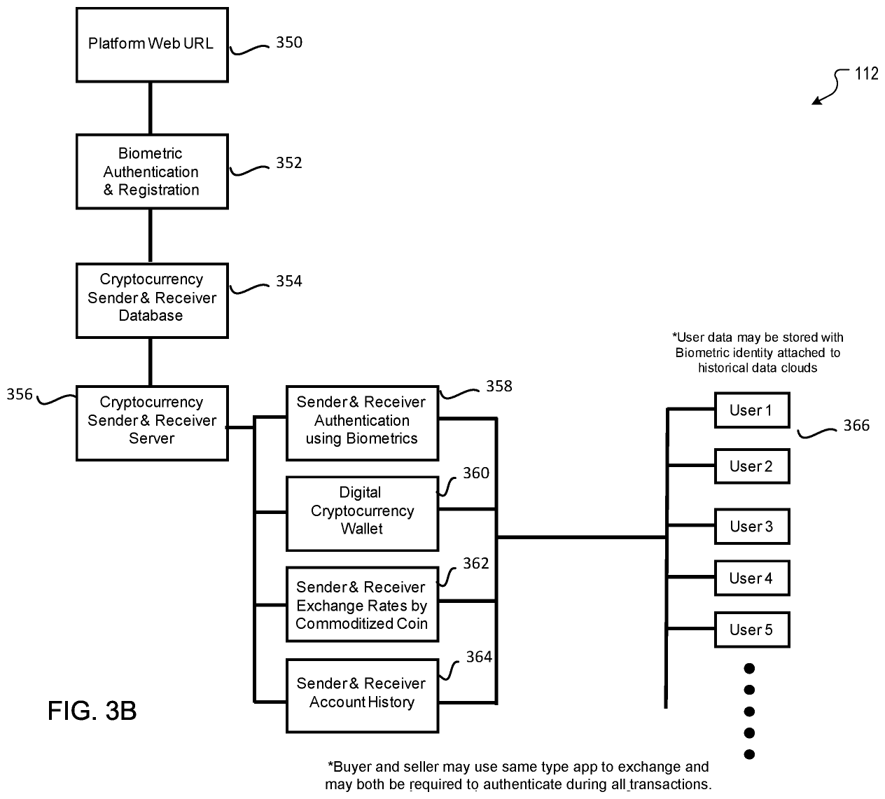

FIG. 3A is a block diagram of an example server 110 that may implement the features and processes associated with server devices as described herein. The server 110 may be implemented on any electronic device that runs software applications derived from compiled instructions, including without limitation personal computers, servers, smart phones, media players, electronic tablets, game consoles, email devices, etc. In some implementations, the server 110 may include one or more processors 302, one or more input devices 304, one or more display devices 306, one or more network interfaces 308, and one or more computer-readable mediums 310. Each of these components may be coupled by bus 312.

Display device 306 may be any known display technology, including but not limited to display devices using Liquid Crystal Display (LCD) or Light Emitting Diode (LED) technology. Processor(s) 302 may use any known processor technology, including but not limited to graphics processors and multi-core processors. Input device 304 may be any known input device technology, including but not limited to a keyboard (including a virtual keyboard), mouse, track ball, and touch-sensitive pad or display. Bus 312 may be any known internal or external bus technology, including but not limited to ISA, EISA, PCI, PCI Express, NuBus, USB, Serial ATA or FireWire. Computer-readable medium 310 may be any medium that participates in providing instructions to processor(s) 302 for execution, including without limitation, non-volatile storage media (e.g., optical disks, magnetic disks, flash drives, etc.), or volatile media (e.g., SDRAM, ROM, etc.).

Computer-readable medium 310 may include various instructions 314 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 304; sending output to display device 306; keeping track of files and directories on computer-readable medium 310; controlling peripheral devices (e.g., disk drives, printers, etc.) which can be controlled directly or through an I/O controller; and managing traffic on bus 312. Network communications instructions 316 may establish and maintain network connections (e.g., software for implementing communication protocols, such as TCP/IP, HTTP, Ethernet, etc.).

Cryptocurrency instructions 318 can include instructions that provide cryptocurrency related functions described herein. For example, cryptocurrency instructions 318 may authenticate user devices (e.g., user device 120), facilitate transactions, perform blockchain operations, etc.

FIG. 3B shows cryptocurrency service 112 which may be implemented by cryptocurrency instructions 318 according to an embodiment of the present disclosure. Cryptocurrency service 112 may include platform website 350, which may include instructions for serving one or more websites to user device 120 so that user device 120 and server device 110 may communicate by the websites. Cryptocurrency service 112 may include biometric authentication and registration 352, which may include instructions for authenticating an individual based on biometric data. Cryptocurrency service 112 may include cryptocurrency sender and receiver database 354, which may include instructions for maintaining cryptocurrency transaction records. Cryptocurrency service 112 may include cryptocurrency sender and receiver server 356, which may include instructions for performing cryptocurrency transactions. Specifically, in some embodiments, cryptocurrency sender and receiver server 356 instructions may include biometric authentication 358, digital wallet 360, exchange rates 362, and/or account history 364. Cryptocurrency service 112 may include user records 366.

Returning to FIG. 3B, application(s) 320 may be an application that uses or implements the processes described herein and/or other processes. The processes may also be implemented in operating system 314.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

### Registration and Security

User device 120 may build a biometric profile of a user to allow the user to authenticate himself or herself with a system such as server 110. Accordingly, a user's own person may function as their key, because the user's visual appearance and/or voice may be matched with the biometric information for future logins and/or transactions. User device 120 may gather biometric information about a user, such as facial and periocular recognition features and, in some embodiments, voice and/or fingerprint features. Biometric features may be extracted and stored as templates for a particular user.

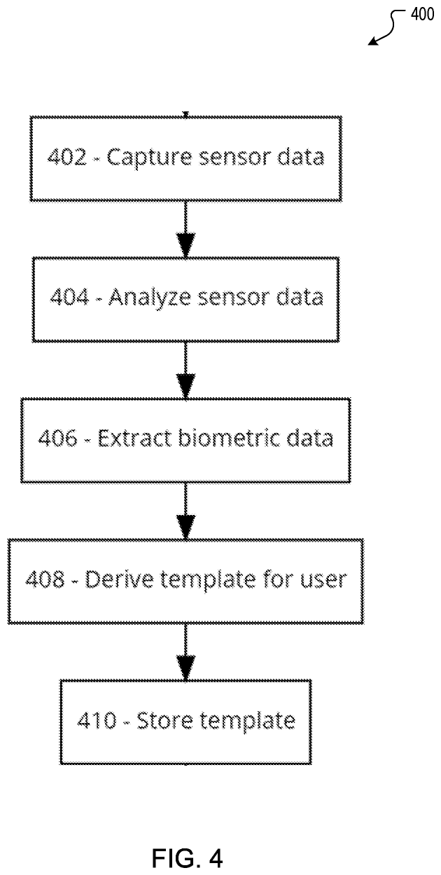

FIG. 4 shows a template creation process 400 according to an embodiment of the present disclosure. In process 400, user device 120 may create a template based on a biometric identity of the user and useable to verify the user's identity for cryptocurrency transactions and/or other purposes.

User device 120 may capture sensor data 402. As noted above, user device 120 may include at least one of a video sensor, a voice sensor, and/or an image sensor. The following example employs a video and/or image sensor. In this example, user device 120 may capture one or more images (e.g., of a user's face). In some embodiments, when both video capture and still image capture are options, user device 120 may utilize video capture preferably to still image capture, because it may be harder to commit fraud with video capture than still image capture. For example, a video may capture a live user's face with relative certainty, because the face will move and change, but in the case of a still image, a user could potentially take a still image of an image of a person, rather than a live person. In some embodiments, user device 120 may require the image capture to use video, rather than still imaging. For example, if a user attempts to submit a still image, user device 120 may reject the image, requiring “liveness” of the image in order to proceed.

User device 120 may analyze the sensor data 404. For example, user device 120 may process captured 2D imagery and/or video to locate a best-matching three-dimensional object from a database of such objects by performing a viewpoint light invariant search. The database may be stored in user device 120 memory and/or in cryptocurrency database 114. In the latter case, user device 120 may communicate with server device 110 to obtain three-dimensional object data. From this processing, user device 120 may identify a 3D object that may be representative of a user's appearance.

User device 120 and/or server device 110 may extract biometric data from the processed sensor data 406. For example, user device 120 and/or server device 110 may identify a face from the 3D object with 2D image overlaid thereon. User device 120 and/or server device 110 may detect periocular data in the sensor data, for example by detecting a pattern around the eye of the person being imaged. User device 120 may detect perilabium data in the sensor data, for example by detecting a pattern of the lips of the person being imaged. In an example where sound data is captured, user device 120 and/or server device 110 may detect sound patterns unique to and/or indicative of the user's voice.

User device 120 and/or server device 110 may derive a template for the user from the biometric data 408. For example, user device 120 and/or server device 110 may apply a vector quantization process to the biometric data to create numbered blocks of data. Image-based and/or video-based data may be ordered into numbered blocks corresponding to a portion of the visual object. Audio-based data may be ordered into numbered blocks corresponding to sections of audio split by time and/or by frequency range. The vector quantization may reduce data storage space requirements, because each block may be stored only once, and repetitive data (e.g., sections that are similar visually or aurally to a previously-seen section) may be represented by reference back to the same block number. One or more blocks may form a template.

User device 120 and/or server device 110 may store the template in memory 410. For example, user device 120 may store the template in local memory 250 and/or may send the template to server device 110 for storage in server device memory 310.

In devices with multiple sensors (e.g., video and audio sensors), process 400 may be repeated for each sensor, and data captured at the same time (e.g., of the same subject) by each sensor may be associated with each other to form a plurality of associated templates for the user or a combined audio/video template for the user.

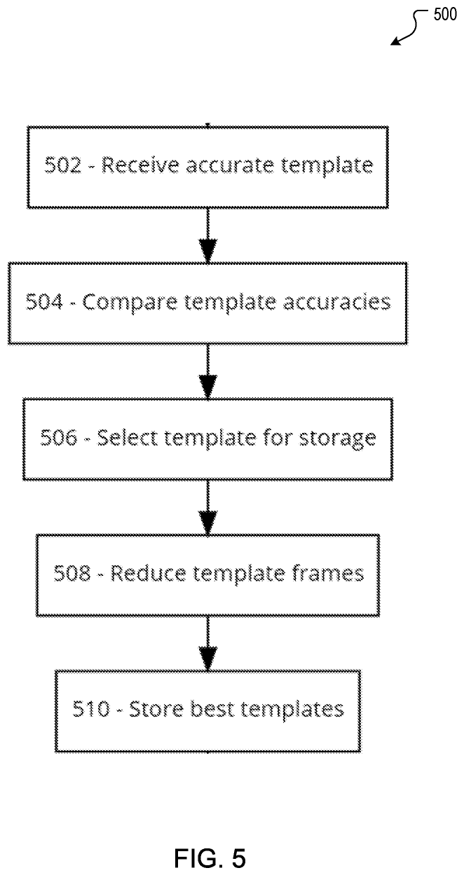

FIG. 5 shows a template improvement process 500 according to an embodiment of the present disclosure. As described below, each time a user logs into their account and/or processes a transaction, user device 120 may perform process 400 to capture a template for the user's biometric data. User device 120 and/or server device 110 may compare the captured template to the template created during registration and/or other stored biometric data of the user. If the captured template matches the stored template and/or other stored biometric data to a specified degree of accuracy or greater (e.g., 99% match or better), the user may be allowed to log in and/or process the transaction. If the match is less than the threshold (e.g., less than 99% match), the user's login attempt and/or transaction attempt may be denied.

Accordingly, each time the user successfully logs in and/or processes a transaction, user device 120 may capture a new template of the user. Server device 110 may perform template improvement process 500 to ensure the most accurate data for matching with templates is available.

Server device 110 may receive an accurate template for a user 502. In some embodiments, this may include receiving sensor data from user device 120 and verifying its accuracy. For example, server device 110 may receive a template created as described above and compare it with one or more stored templates for the user in server device 110 memory, using one or more matching algorithms (e.g., which may be any visual matching algorithm known in the art). If the template is more accurate than a threshold level (e.g., 99%), the template may be considered accurate. In other embodiments, server device 110 may receive a template that has already been verified as accurate at this stage.

Server device 110 may compare the accurate template with stored templates known to be accurate 504. Server device 110 may evaluate the accurate template's degree of accuracy against degrees of accuracy of templates that are stored in server device 110 memory. For example, server device 110 may receive an accurate template that is 99.5% accurate according to the matching algorithm. Server device 110 may have a set of known accurate templates stored in memory, each of which may have a specific degree of accuracy. For example, server device 110 may store five templates. In this example, four of the stored templates have accuracies greater than 99.5%, and one has an accuracy of 99.4%. Server device 110 may rank the templates, including both the stored templates and the newly received template, in order of accuracy and/or identify one or more lowest-ranked templates from among both the stored templates and the newly received template.

Server device 110 may evaluate whether to update the stored templates, for example by selecting a set of templates from among both the stored templates and the newly received template to store 506. For example, server device 110 may maintain a set of five templates for the user in memory (other embodiments may maintain different numbers of templates for each user). If the comparison identifies the newly received template as having better accuracy than one of the previously-stored templates, server device 110 may select the lowest accuracy template in memory for replacement with the newly received template. If the comparison determines that the newly received template has lower accuracy than all the stored templates, process 500 may end at this point.

Assuming server device 110 has selected the newly received template for storage, server device 110 may generate a reduced-size subset of the data in the template to store in memory 508. For example, the template may include a video stream comprising a plurality of video frames, and server device 110 may reduce the video stream to a subset of frames. In another example, server device 110 may divide the sensor data (e.g., video stream) into small chunks called vector blocks and assign a unique number to each block. After creating vector blocks, server device 110 may compare all blocks to find similar blocks. If any blocks are similar, server device 100 may reduce the similar blocks to a single block with a single block number and a recorded association of blocks, so that only one block needs to be stored in memory for all the similar data. This process may reduce the data size for storage. Server device 110 may analyze each block for data characteristics that may be used for similarity analysis as described above (e.g., standard deviation, mean value, variance, etc.).

Note that in some embodiments, the reduced template may be useful for performing the comparing for identity verification described above. For example, to determine whether a newly captured template is a match to the stored templates, server device 110 may divide the newly captured template into vector blocks and compare the newly captured template to the stored templates on a vector block by vector block basis. Based on the similarity of block characteristics (e.g., standard deviation, mean value, variance, etc.), server device 110 may determine a degree of similarity between the new template and the stored templates.

Server device 110 may store the reduced template (or the full template in some embodiments where reduction 508 is not performed) in memory along with the other templates for the user. By adding more accurate templates to the memory, server device 110 may improve the security of the user's login. Process 500 may be repeated periodically, for example every time a user logs into an app on user device 120. Each time a more accurate template is captured, process 500 may improve the accuracy of the stored templates. In some embodiments, after at least six months' worth of data is accumulated, the user profile may be regarded to have 100% accuracy. Six months may be a normal range of time for ensuring the data is statistically significant enough to have a relevancy needed and to ensure the identity is true and error free in matching.

### Cryptocurrency Functions

User device 120 and server 110 may be configured to provide cryptocurrency functions. For example, a user may install an app providing cryptocurrency functions on user device 120, or the user may access an interface of server 110 providing cryptocurrency functions using a web browser app.

To gain permission to execute transactions using cryptocurrency, the user may register with the system. For example, user device 120 may provide a user interface (UI) through the app or browser. Through user input in the UI, user device 120 may gather information about the user to create a profile. For example, the information may include phone number, date of birth, location, and bank account number and routing number of an account. User device 120 may gather biometric information about the user, such as facial and periocular recognition features and, in some embodiments, voice and/or fingerprint features, as discussed above.

A registered user can use their authentication data (e.g., facial and periocular recognition features, voice features, and/or fingerprint features) to purchase coins. In some embodiments, the user may authenticate through the UI provided by user device 120 using facial and periocular recognition features, and additional verification may be applied by using phone one-time password, fingerprint, or voice. Once the user is authenticated, the user may purchase coins. A coin purchase may cause the user's bank account to be debited and currency to be converted from current currency stored in a bank account to cryptocurrency coins. The user may be notified about the transaction through email, SMS, and in the user's profile inbox which may be provided by the UI. The user's transaction history may be maintained so the user can view a cryptocurrency account statement in the UI.

A user may perform transactions through the UI provided by user device 120. For example, the user may initiate a request (e.g., a request to send money or pay for an item) with biometric authentication using facial and periocular recognition. The user may authenticate and may enter an amount of value to transfer. Server 110 may use an algorithm to select the best commodities to use for immediate purchase to conserve commodities that are of a higher value. The commodities may be assigned to the buyer through their biometric profile. The user's identity may be verified for acceptance, and the coins may be stored against the user's biometric profile as a credit to their account is stored. During the storing process the value can increase or decrease in value.

The seller or other party to the transaction may authenticate the transaction. Server 110 may issue a number (hash) for the transaction, and the coins may be provided to the seller. These coins may be stored into the seller's profile and can fluctuate in value based on daily rates of a backing commodity. Processing may take 3 to 5 seconds to process. Once complete the transaction is final.

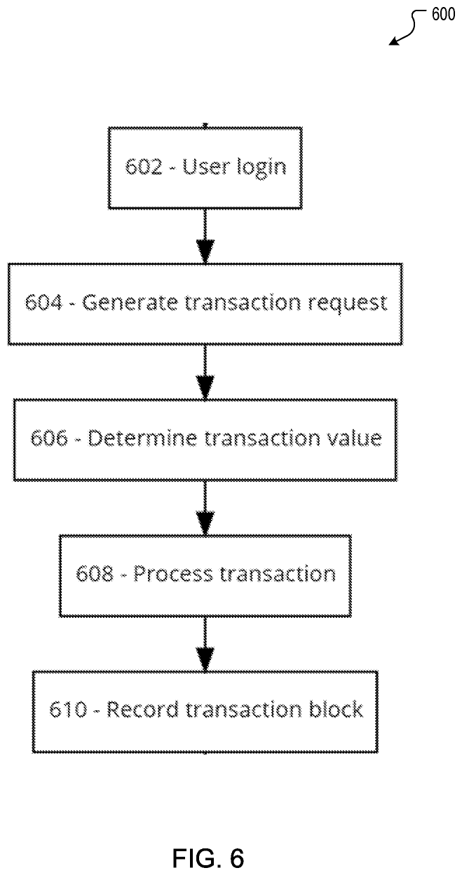

FIG. 6 shows a transaction process 600 according to an embodiment of the present disclosure. A user wishing to conduct a transaction may login 602, for example by performing the biometric scan at user device 120 as discussed above (e.g., see processes 400 and 500) and/or providing additional information such as a username and/or password. The first time a user logs in (e.g., to create an account), user device 120 may generate a user template (e.g., see process 400) and require a user to create a wallet including bank information. The user may provide bank information and/or other account information, such as identifying information, to populate the wallet. For example, server 110 may store coins purchased by the user in a virtual wallet maintained by the server and associated with the user's identity. Biometric data associated with the user's identity may be stored separately from the virtual wallet.

User device 120 may generate a transaction request and send it to server device 110 based on user input 604. The following example supposes the user would like to buy a cryptocoin, but a user may also sell coins and/or exchange coins for goods or other currencies with other users. To buy a coin, the user may select bank(s) associated with their profile (e.g., during the setup described above) through the UI provided by user device 120. The user may select an amount to spend and identify a particular type of coin to buy, e.g., selfieGOLD (backed by gold), selfieDIAMOND (backed by diamonds), selfiePLATINUM (backed by platinum), selfieBLACKSANDS (backed by blacksands), and/or other currencies.

Server device 110 may determine a value for the transaction 606. All currency may be backed by commodities as noted above. During each transaction, unless the user specified a particular currency to use, a lower valued commodity may be used for a transaction versus a commodity worth more in value. Server device 110 may use an automated algorithm to determine the release of the lesser in value digital currency in an individual's possession. For example, server device 110 may determine the value of each underlying commodity based on a daily snapshot value obtained from external commodity exchanges and/or real-time tracking data provided by the external commodity exchanges. Server device 110 may select the lowest-valued commodity as the backing commodity for the transaction. If a user has no coins backed by the selected commodity, or not enough coins backed by the selected commodity to cover the transaction, server device 110 may move to the next-lowest valued commodity, and so on until the transaction is completely paid for. This may allow users to maintain and realize the maximum value from the currency they own at all times.

Server device 110 may process the transaction 608. Server 110 may require biometric authentication from all parties to the transaction. When authentication is achieved by all parties, server 110 may direct the bank(s) to process the transaction. Other users in the network 100 (e.g., other user devices 120) may conduct a mutual authentication on both the buyer and seller side and exchange the valued commodity at the real-time daily value of the commodity backing the coin.

Server device 110 may record the transaction 610. For example, server device 110 may utilize any blockchain algorithm to maintain a blockchain serving as a distributed ledger of transactions. Each block in the blockchain may include a transaction record. A transaction record may include, for example, transaction data (e.g., value of coins exchanged, backing commodity information, payor and payee information, transaction location, etc.) and authentication data for each party to the transaction (e.g., template data generated as described above).

As may be the case for many blockchain algorithms, blocks may be created by coin miners and assigned authentication headers. A miner may perform the processing necessary to construct a block memorializing the transaction. When a block is complete, the miner may authenticate themselves (e.g., using biometric authorization as described above), and the authentication may be verified by a responsive and live individual that may provide a numeric code for the transactor which is valued at the real-time value of the coin earned through the mining procedure.

Over time, as data is collected, server device 110 may generate and populate individual mini “geniusclouds” for individual users that may include the user's historical data. For example, the user data may include references to the blocks in which the user's own transaction records are stored. The user data may be maintained in the territory or country in which the individual resides.

In some embodiments, cryptocurrency coins may be mined according to one or more cryptocurrency algorithms. Suitable algorithms may include any known cryptocurrency blockchain algorithm and/or one or more proprietary algorithms. Peer devices (e.g., user devices 120) may verify and/or process transactions as noted above, using a cryptocurrency blockchain algorithm, and thereby mine coins. The following example uses a “cryptoselfie” algorithm to demonstrate this process.

The cryptoselfie algorithm may be suitable for online, mobile, and in-store experiences in open sourced protocols, which may allow for privacy increase and accuracy in cryptocurrency transactions. The cryptoselfie algorithm may depend on previous biometric “selfieblocks” for each new block. The cryptoselfie algorithm hash rate may be measured by H/S hash computations per second.

A transaction block may include a header, a block, a nonce, and a hash. Miners may compete to match the block of the block's stock header and the value notation with a nonce to get an alphanumeric code called a hash. The hash may have a value based on the value to date of the commodity being hedged to create the value of the coin. The value may be assigned a value based on current market value of the commodity, for example.

Before the hash is created, an algorithm may be used to determine the commodity owned with the lowest value and, based on the determined lowest value, the lowest commodity value may be paid out first and proceeding higher values may be distributed out until the total amount is assembled as a block to be paid out to the receiver. When sending funds to a receiver, this process may occur, and then the hash may be created once the block is sent to the receiver. Each hash accepted by the network 100 community may be rewarded with coins based on ascending value of the commodities chosen for the transaction.

The hash values may be added to the next selfieblock stock header with a value, creating a block chain connected to the biometric supported block of the transactor. The blockchain may serve as a public ledger of all transactions that have made transactions in the network 100 community.

The commodity may be held in a bank, and the currency may be hedged against the commodities offered in the community through a centralized account management system “bankgenius” provided by server device 110. Bankgenius may manage the commodities and aid in the distribution and management of the digital currency to transactors. Bankgenius may provide a holding account for registered users with digital currency held and not in use. Users may be issued a bankgenius account number automatically that can be used after a profile is created to exchange coins. The user's account may function as an automatic digital bank account for holding digital currency funds not being exchanged.

### Additional Features

Artificial Intelligence (AI) may be used to simulate human intelligence around the data collected from users. For example, as noted above transaction information may be recorded in blocks and associated with the transaction parties through geniusclouds. Server device 110 may analyze the collected data for each party to identify transaction trends and make predictions based thereon. For example, server device 110 may analyze transaction data to identify times of day and/or days of the week during which a person most frequently makes transactions, identify parties (e.g., vendors) with whom the person most frequently makes transactions, identify patterns suggesting the person initiates transactions spontaneously or after more deliberate consideration, identify types of goods purchased in transactions, etc. Server device 110 may use the analysis to forecast user behavior. Trends may be provided to the user through user device 120 to help the individual with self-managing funds, timing of distribution of funds, and providing intelligence on how to manage funds backed by commodities allowing individuals to make money off the digital currency they own or hold by making intelligent decisions regarding the funds they pay with or hold onto to use at a later time after accumulating an increase in value of their digital currency commodity being hedged or valued daily with market daily trending of commodities. Server device 110 may also use trends to identify offers and/or vendors that may be of interest to the user and share this information with the user through user device 120. In some embodiments, user device 120 may provide an AI agent interface configured to provide responses to verbal requests, for example communicating analyzed data collected, providing financial guidance to the user, and/or sharing offers.

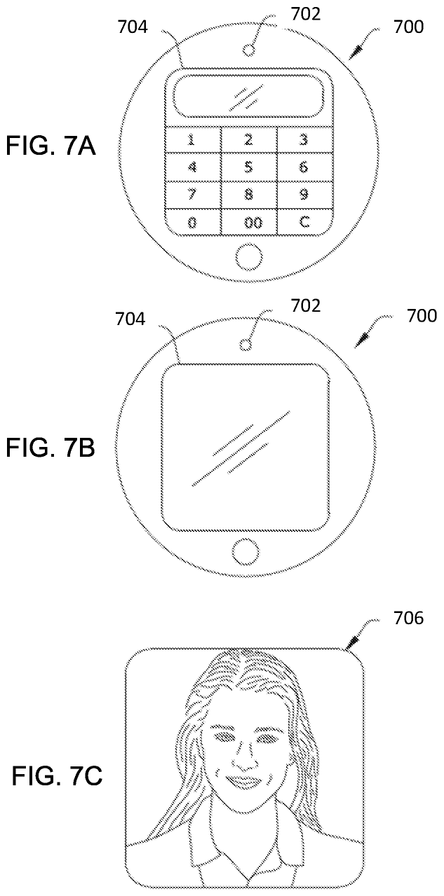

FIGS. 7A-7C show a standalone selfie reader 700 according to an embodiment of the present disclosure. While the examples above involve user device 120, which may receive input from a user, in some examples, a user may wish to conduct a transaction while not in possession of a user device. Reader 700 may be provided at one or more points of sale, for example, and may be configured to perform the functions of user device 120 as described above. In some embodiments, reader 700 may be a wireless unit that may be in communication with a computing device (e.g., provided by the point of sale), and together the reader 700 and computing device may perform the functions of user device 120 as described above.

Reader 700 may have a camera 702 for capturing biometric data, for example where the camera 702 may be used to capture biometric data in the form of a self-image 706. Reader 700 may have a user interface and/or screen 704 (e.g., a touch screen) unto which electronic representations of the captured self-image 706 may be provided. Additionally, the screen may provide an electronic representation of a key pad through which a user can enter identification/pin and payment information. Reader 700 may be adapted to allow the user to provide biometric data, then enter a pin or numeric value to verify a payment transaction. In addition, reader 700 may capture the biometric data only to facilitate the transaction processing for the user, wherein a transaction value may be provided by the point of sale (e.g., by scanning a bar code of a product being purchased). In some embodiments, reader 700 may be equipped with a CPU, memory, camera flash, Bluetooth transceiver, chip reader, magnetic stripe card reader, power button, speaker, indicator LED, battery and charging capability, and/or photo exportation capabilities. Reader 700 may be adapted to receive payment information from a credit card and/or user device 120 in addition to performing the biometric identification and payment processing described above.

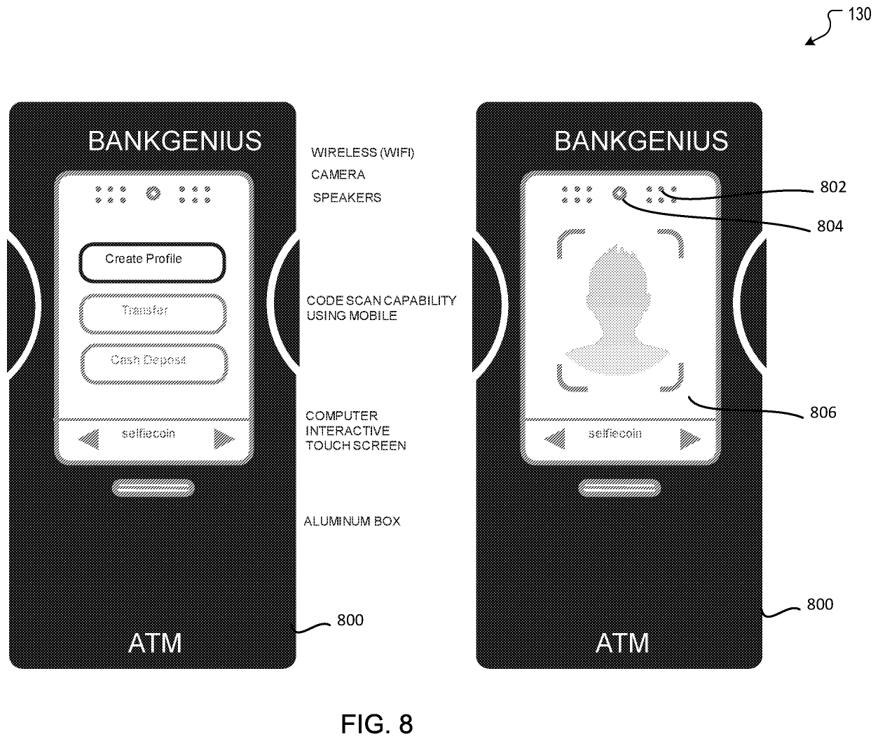

FIG. 8 shows an ATM 130 according to an embodiment of the present disclosure. The system may have its own cryptocurrency exchange ATM 130 which may be configured to convert cash to digital currency or digital currency to cash. ATM 130 may include a body 800, which may house common ATM machinery such as a cash box, cash dispensing apparatus, cash reader, etc. ATM 130 may also include speakers 802, a camera 804, and a touchscreen 806 or other visual interface. ATM 130 may include WiFi and/or other networking capabilities for communicating with user device 120. ATM 130 may be coupled to server device 110 by network 100.

A user may login to ATM 130 as described above. For example, the user may perform a biometric login using ATM 130 camera 804 and/or using their own user device 120 communicating with ATM 130 by WiFi. The user may use touchscreen 806 and/or user device 120 to select tasks to perform (e.g., profile creation, transfer of cryptocurrency, cash deposit to be converted to cryptocurrency, cash withdrawal from cryptocurrency).

ATM 130 may have code scan capability (e.g., QR code or any other type). For example, ATM 130 may communicate with user device 120 to receive scanned codes and/or the user may be able to use ATM 130 camera 804 to scan codes. Codes may be given to users as a means of crediting coins to the user's account (e.g., as promotions by businesses or the like).

In some embodiments, ATM 130 may be located within a kiosk, and a user may have to log into their account using a biometric scan on their user device 120, which may be in wireless communication with ATM 130, to enter the kiosk.

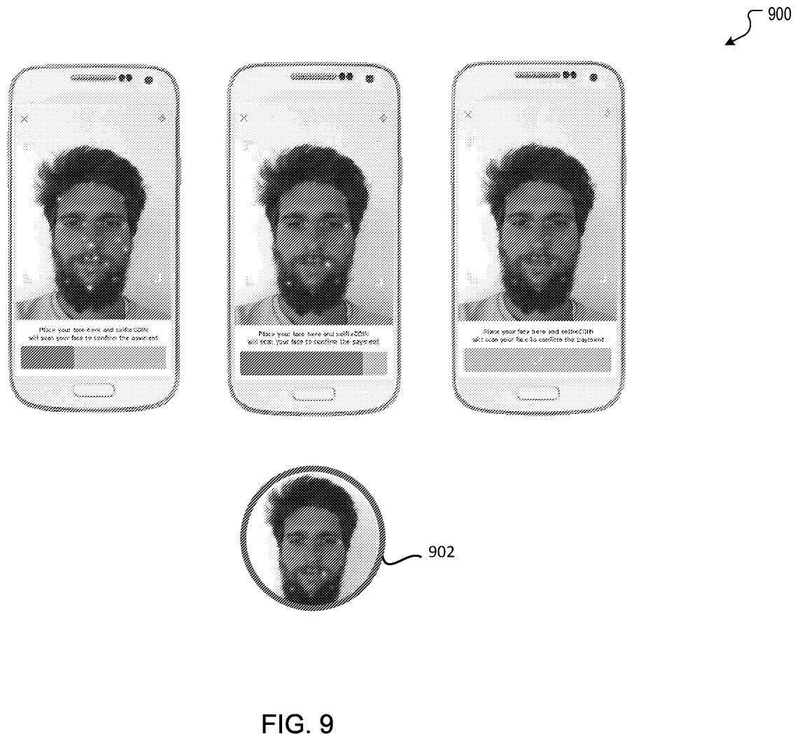

FIG. 9 shows a verification interface 900 according to an embodiment of the present disclosure. Verification interface 900 may be used by ATM 130 and/or by user device 120. Authentications may be animated, for example with a bar showing authentication progress and dots forming on the face with them changing colors during authentication, as shown. Other animations may include forming dimensional shapes over the face that explode when animation is complete, voice animation of the coin with the user's animated face represented on the coin, etc. The animations may allow users to understand when an authentication is complete. After completion, an animated coin 902 may be created representing that the individual currency has been received. For example, a recipient of a coin in the transaction may receive animated coin 902. After transaction, a text may be sent to both receiver and sender to provide record a transaction was completed.

A user may be able to select the type of authentication animation experienced while engaging in the authentication process. Example animations may include dots that transition into colors, represented on the users face during the processing of the authentication of the user, wherein after authentication completion, all dots transition to a specific color selection. Another example animation may include a mask of three dimensional triangles formed over the face wherein, once the authentication is complete, the mask explodes off the face. Another example animation may include a mask formed over the face that dissolves after authentication. In other examples, customizable animated authentication offerings may include other emojis, motion graphics, and/or forms of digital artifacts, for example. The different authentication experiences may provide an interesting transactional experience for the profile users.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1-29. (canceled)

30. A method, comprising:
receiving, by at least one processor, sensor data captured by at least one sensor in communication with the at least one processor;
extracting, by the at least one processor, biometric data from the sensor data
comparing, by the at least one processor, the biometric data with stored biometric data for a first user stored in at least one memory in communication with the at least one processor;
determining, by the at least one processor, that the biometric data matches the stored biometric data based on the comparing;
executing, by the at least one processor, a transaction between the first user and a second user, the transaction comprising an exchange of digital currency between the first user and the second user; and
creating, by the at least one processor, a block in a distributed blockchain, the block comprising data memorializing the transaction including information describing the exchange of the digital currency and at least one of the biometric data and the stored biometric data.

31. The method of claim 30, further comprising: receiving, by the at least one processor, second sensor data captured by at least one second sensor in communication with the at least one processor;
extracting, by the at least one processor, second biometric data from the sensor data;
comparing, by the at least one processor, the second biometric data with second stored biometric data for the second user stored in the memory; and
determining, by the at least one processor, that the second biometric data matches the second stored biometric data based on the comparing;
wherein the block data memorializing the transaction further includes at least one of the second biometric data and the second stored biometric data.

32. The method of claim 31, wherein:
the sensor data comprises video data; and
the extracting comprises identifying a face within a plurality of frames of the video data.

33. The method of claim 32, wherein the extracting further comprises mapping the identified face to a three-dimensional object and generating a template including a pattern comprising a subset of points on the three-dimensional object.

34. The method of claim 33, wherein identifying the face comprises identifying a pattern around an eye of the face, identifying a pattern around lips of the face, or a combination thereof.

35. The method of claim 34, further comprising:
generating, by the at least one processor, a reduced data set of the biometric data that is representative of the biometric data; and
storing, by the at least one processor, the reduced data set as at least a portion of the stored biometric data.

36. The method of claim 35, wherein the stored biometric data comprises a plurality of separate biometric data sets, the method further comprising:
determining, by the at least one processor, a match accuracy of the biometric data;
determining, by the at least one processor, stored data match accuracies for each separate biometric data set;
determining, by the at least one processor, that the match accuracy of the biometric data is greater than at least one of the stored data match accuracies; and
replacing, by the at least one processor, a least accurate separate biometric data set in the memory with at least a portion of the biometric data in response to the determining that the match accuracy of the biometric data is greater than at least one of the stored data match accuracies.

37. The method of claim 36, wherein:
the digital currency comprises a plurality of currencies, each of the plurality of currencies being backed by a different commodity; and
executing the transaction comprises selecting at least one of the plurality of currencies to exchange between the first user and the second user.

38. The method of claim 37, wherein the selecting comprises determining a lowest-value commodity of the commodities backing the plurality of currencies and selecting the lowest-value commodity.

39. The method of claim 38, wherein the information describing the exchange of the digital currency comprises at least one of a currency sender, a currency receiver, a value of the transaction, a commodity and/or currency used in the transaction, a location for the transaction, or a combination thereof.

40. The method of claim 39, further comprising generating, by the at least one processor, at least one recommendation for the first user based on the information describing the exchange of the digital currency.

41. The method of claim 40, wherein the sensor data is received from at least one user device, at least one automatic teller machine, at least one dedicated reader device, or a combination thereof.

42. The method of claim 41, further comprising causing, by the at least one processor, an animation to be displayed in response to the executing.

43. The method of claim 42, wherein the animation is user-selectable.

44. A transaction system, comprising:
at least one memory; and
at least one processor in communication with the at least one memory, the at least one processor configured to perform processing comprising: receiving sensor data captured by at least one sensor in communication with the at least one processor;
extracting biometric data from the sensor data;
comparing the biometric data with stored biometric data for a first user stored in the memory;
determining that the biometric data matches the stored biometric data based on the comparing;
executing a transaction between the first user and a second user, the transaction comprising an exchange of digital currency between the first user and the second user; and
creating a block in a distributed blockchain, the block comprising data memorializing the at least one transaction including information describing the exchange of the digital currency and at least one of the biometric data and the stored biometric data.

45. The system of claim 44, wherein:
the processing further comprises:
receiving second sensor data captured by at least one second sensor in communication with the at least one processor;
extracting second biometric data from the sensor data;
comparing the second biometric data with second stored biometric data for the second user stored in the memory; and
determining that the second biometric data matches the second stored biometric data based on the comparing; and
the block data memorializing the at least one transaction further includes at least one of the second biometric data and the second stored biometric data.

46. The system of claim 45, wherein:
the sensor data comprises video data; and
the extracting comprises identifying a face within a plurality of frames of the video data.

47. The system of claim 46, wherein the extracting further comprises mapping the identified face to a three-dimensional object and generating a template including a pattern comprising a subset of points on the three-dimensional object.

48. The system of claim 47, wherein identifying the face comprises identifying a pattern around an eye of the face, identifying a pattern around lips of the face, or a combination thereof.

49. The system of claim 48, wherein the processing further comprises:
generating a reduced data set of the biometric data that is representative of the biometric data; and
storing the reduced data set as at least a portion of the stored biometric data.

50. The system of claim 49, wherein:
the stored biometric data comprises a plurality of separate biometric data sets; and
the processing further comprises:
determining a match accuracy of the biometric data;
determining stored data match accuracies for each separate biometric data set;
determining that the match accuracy of the biometric data is greater than at least one of the stored data match accuracies; and
replacing a least accurate separate biometric data set in the memory with at least a portion of the biometric data in response to the determining that the match accuracy of the biometric data is greater than at least one of the stored data match accuracies.

51. The system of claim 50, wherein:
the digital currency comprises a plurality of currencies, each of the plurality of currencies being backed by a different commodity; and executing the transaction comprises selecting at least one of the plurality of currencies to exchange between the first user and the second user.

52. The system of claim 51, wherein the selecting comprises determining a lowest-value commodity of the commodities backing the plurality of currencies and selecting the lowest-value commodity.

53. The system of claim 52, wherein the information describing the exchange of the digital currency comprises at least one of a currency sender, a currency receiver, a value of the transaction, a commodity and/or currency used in the transaction, a location for the transaction, or a combination thereof.

54. The system of claim 53, wherein the processing further comprises generating at least one recommendation for the first user based on the information describing the exchange of the digital currency.

55. The system of claim 54, wherein the processing further comprises causing an animation to be displayed in response to the executing.

56. The system of claim 55, wherein the animation is user-selectable.

57. The system of claim 56, wherein the sensor data is received from at least one user device, at least one automatic teller machine, at least one dedicated reader device, or a combination thereof.

58. The system of claim 57, wherein:
the at least one processor comprises a server processor and a plurality of distributed processors; and
the plurality of distributed processors are configured to perform the creating of the block.
